(19) United States
(12) Patent Application Publication
(10) Pub. No.: US 2022/0207297 A1
(43) Pub. Date: Jun. 30, 2022

(54) DEVICE FOR PROCESSING UNBALANCED DATA AND OPERATION METHOD THEREOF

(71) Applicant: Electronics and Telecommunications Research Institute, Daejeon (KR)

(72) Inventors: Youngwoong HAN, Daejeon (KR); Hwin Dol PARK, Daejeon (KR); Jae Hun CHOI, Sejong-si (KR)

(73) Assignee: Electronics and Telecommunications Research Institute, Daejeon (KR)

(21) Appl. No.: 17/551,820

(22) Filed: Dec. 15, 2021

(30) Foreign Application Priority Data
Dec. 30, 2020 (KR) 10-2020-0188407

(51) Int. Cl. G06K 9/62

(52) U.S. Cl. CPC G06K 9/6256; G06K 9/6298; G06K 9/627; G06K 9/6215; G06K 9/6262

(57) ABSTRACT

Disclosed is a data processing device that processes unbalanced data, which includes a preprocessor that calculates a reference value based on a plurality of training data and target data, and a learner that applies the plurality of training data to a first weight model to generate first prediction data, calculates a loss value based on a first distance between the target data and the reference value and a second distance between the target data and the first prediction data, and updates the first weight model based on the calculated loss value, and the plurality of training data and the target data have an unbalanced distribution.

### CROSS-REFERENCE TO RELATED APPLICATIONS

This application claims priority under 35 U.S.C. § 119 to Korean Patent Application No. 10-2020-0188407, filed on Dec. 30, 2020, in the Korean Intellectual Property Office, the disclosures of which are incorporated by reference herein in their entireties.

### BACKGROUND

Embodiments of the present disclosure described herein relate to processing of time series data, and more particularly, relate to an unbalanced data processing device for generating a weight model for unbalanced data, and an operating method thereof.

Machine learning performs learning based on training data to generate a weight model, and predicts data based on the generated weight model. Machine learning may perform best when the distribution of training data is uniform. As an example of a classification issue, when a weight model is trained based on 1000 pictures of cats and 1 picture of a dog, the weight model is biased towards the pictures of cats, which increases the probability of classifying it as a cat with respect to a variety of different types of pictures.

The above issue also applies equally to a case of a regression model. For example, the regression model trained based on training data in which the number of data having a specific value or a value in a specific region is relatively large outputs the specific value or the value in the specific region with respect to various input data. That is, the reliability of machine learning may be lowered due to the training data having an unbalanced distribution.

### SUMMARY

Embodiments of the present disclosure provide a device for processing unbalanced data having improved reliability and an operating method thereof.

According to an embodiment of the present disclosure, a data processing device that processes unbalanced data, which includes a preprocessor that calculates a reference value based on a plurality of training data and target data, and a learner that applies the plurality of training data to a first weight model to generate first prediction data, calculates a loss value based on a first distance between the target data and the reference value and a second distance between the target data and the first prediction data, and updates the first weight model based on the calculated loss value, and the plurality of training data and the target data have an unbalanced distribution.

According to an embodiment, the reference value may be one of a mode value, a median value, and a mean value associated with the plurality of training data and the target data.

According to an embodiment, the preprocessor may include a normalizer that performs a normalization operation on a data set from an external training database to generate the plurality of training data and the target data, a reference value calculator that calculates the reference value based on the plurality of training data and the target data, and a first distance calculator that calculates the first distance based on the target data and the reference value.

According to an embodiment, the learner may include a first weight model generator that generates the first weight model from an external weight model database, a first prediction calculator that calculates the first prediction data by applying the training data to the first weight model, a second distance calculator that calculates the second distance based on the target data and the first prediction data, a loss calculator that calculates the loss value based on the first distance and the second distance, and a model updater that updates a plurality of parameters and a plurality of weights included in the first weight model based on the loss value to generate a second weight model, and to store the second weight model in the external weight database.

According to an embodiment, the normalizer may perform the normalization operation on a data set from an external target database to generate a plurality of input data, and the data processing device may further include a predictor that applies the plurality of input data to a weight model from the external weight model database to generate result data.

According to an embodiment, the predictor may include a second weight model generator that generates the weight model from the external weight database, a second prediction calculator that calculates result data by applying the plurality of input data to the weight model, and an inverse normalizer that performs an inverse normalization operation on the second prediction data and store the inverse normalized second prediction data in an external prediction result database.

According to an embodiment, the loss calculator may calculate the loss value using a loss function based on the first distance and the second distance.

According to an embodiment, the loss value may increase as the first distance or the second distance increases.

According to an embodiment, a first increase amount of the loss value depending on an increase of the second distance when the first distance is a first value may be less than a second increase amount of the loss value depending on the increase of the second distance when the first distance is a second value greater than the first value.

According to an embodiment, the learner may select one of a plurality of algorithms based on the first distance, and may calculate the loss value based on the first distance and the second distance using the selected algorithm.

According to an embodiment, the plurality of training data may be time series data.

According to an embodiment of the present disclosure, a method of operating a data processing device configured to process unbalanced data includes calculating a reference value based on a plurality of training data and target data, calculating a first distance between the target data and the reference value, generating first prediction data by applying the plurality of training data to a first weight model generated from an external weight model database, calculating a second distance between the target data and the first prediction data, calculating a loss value based on the first distance and the second distance, and generating a second weight model by updating the first weight model based on the loss value, and storing the second weight model in the external weight model database.

According to an embodiment, a first increase rate of the loss value depending on the second distance when the first distance is a first value may be less than a second increase rate of the loss value depending on the second distance when the first distance is a second value greater than the first value.

According to an embodiment, the loss value may increase as the first distance or the second distance increases, and when the first distance is less than a reference distance, a loss value may be calculated based on the first distance and the second distance using a first algorithm, and when the first distance is greater than the reference distance, the loss value may be calculated based on the first distance and the second distance using a second algorithm, and a first change rate of the loss value depending on a change of the second distance by the first algorithm may be less than a second change rate of the loss value depending on a change of the second distance by the second algorithm.

According to an embodiment, the method may further include generating result data by applying the plurality of input data to the weight model generated from the external weight model database.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a data processing device according to an embodiment of the present disclosure.

FIG. 2 is a graph describing training data used in a data processing device of FIG. 1.

FIG. 3 is a diagram illustrating a form of data used in a data processing device of FIG. 1.

FIG. 4 is a diagram describing a learning process of a data processing device of FIG. 1.

FIGS. 5A to 5G are graphs describing an operation of a loss calculator of FIG. 4.

FIG. 6 is a diagram describing a prediction process of a data processing device of FIG. 1.

FIG. 7 is a flowchart illustrating an operation of a data processing device of FIG. 1.

FIG. 8 is a flowchart illustrating an operation of a data processing device of FIG. 1.

FIG. 9 is a diagram illustrating a health state prediction system to which a data processing device according to the present disclosure is applied.

FIG. 10 is a block diagram illustrating a data processing device according to an embodiment of the present disclosure.

### DETAILED DESCRIPTION

Hereinafter, embodiments of the present disclosure will be described clearly and in detail such that those skilled in the art may easily carry out the present disclosure.

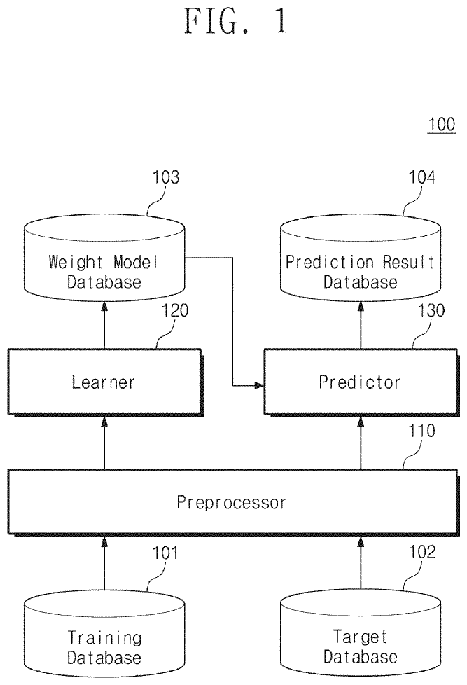

FIG. 1 is a block diagram illustrating a data processing device according to an embodiment of the present disclosure. Referring to FIG. 1, the data processing device 100 may include a preprocessor 110, a learner 120, and a predictor 130. In an embodiment, the data processing device 100 may be a data processing device or a machine learning device configured to preprocess time series data and to analyze the preprocessed time series data to train a prediction model, or to generate a prediction result.

The preprocessor 110, the learner 120, and the predictor 130 may be implemented with hardware or may be implemented with firmware, software, or a combination thereof. In an embodiment, the software (or the firmware) may be loaded onto a memory (not illustrated) included in the data processing device 100 and may be executed by a processor (not illustrated). In an embodiment, the preprocessor 110, the learner 120, and the predictor 130 may be implemented with hardware such as a field programmable gate array (FPGA) or a dedicated logic circuit such as an application specific integrated circuit (ASIC).

The preprocessor 110 may perform preprocessing on data used in a learning process or a prediction process. For example, a training database 101 may include data (i.e., training data) to be learned by the learner 120. The preprocessor 110 may perform normalization on the training data and may calculate a first distance associated with the normalized training data. In an embodiment, the first distance may refer to an error, a difference, or a logical distance between a reference value for the normalized training data and a target data. A target database 102 may include data (i.e., input data) to be input to the predictor 130. The preprocessor 110 may perform normalization on the input data, and may transfer the normalized input data to the predictor 130. A configuration and an operation of the preprocessor 110 will be more fully described with reference to drawings below.

The learner 120 may update the weight model based on the normalized training data and the first distance received from the preprocessor 110. For example, the learner 120 may calculate the prediction data based on the normalized training data received from the preprocessor 110, and may calculate a second distance based on the calculated prediction data. In an embodiment, the second distance may refer to an error, a difference, or a logical distance between the actual data corresponding to prediction data among the normalized training data and the prediction data. The learner 120 may calculate a loss value based on the above-described first distance and the second distance, and update the weight model based on the calculated loss value. The updated weight model may be stored in a weight model database 103. In an embodiment, the above-described loss value may be compensated for at different rates depending on the first distance and the second distance. A configuration and an operation of the learner 120 will be more fully described with reference to drawings below.

The predictor 130 may receive the normalized input data from the preprocessor 110, may generate a weight model based on the weight model database 103, and may apply the normalized input data to the generated weight model to calculate or generate the prediction data. In an embodiment, the prediction data generated by the predictor 130 may be result data that is the final result of machine learning. The predictor 130 may store the calculated prediction data in a prediction result database 104. A configuration and an operation of the predictor 130 will be more fully described with reference to drawings below.

In an embodiment, each of the training database 101, the target database 102, the weight model database 103, and the prediction result database 104 may be implemented in a server or storage medium external or internal to the data processing device 100. In an embodiment, the training database 101, the target database 102, the weight model database 103, and the prediction result database 104 may be implemented with a single storage device or a server.

As described above, the learner 120 of the data processing device 100 according to the present disclosure may calculate the loss value based on the first distance and the second distance of the training data, and may update the weight model based on the calculated loss value. In this case, the loss value may increase as the first distance increases. In addition, as the second distance increases, an increased amount of the loss value by the first distance may increase. That is, since a relatively large loss value may be reflected with respect to a relatively small number of training data, the reliability of the prediction data of the data processing device 100 may be improved.

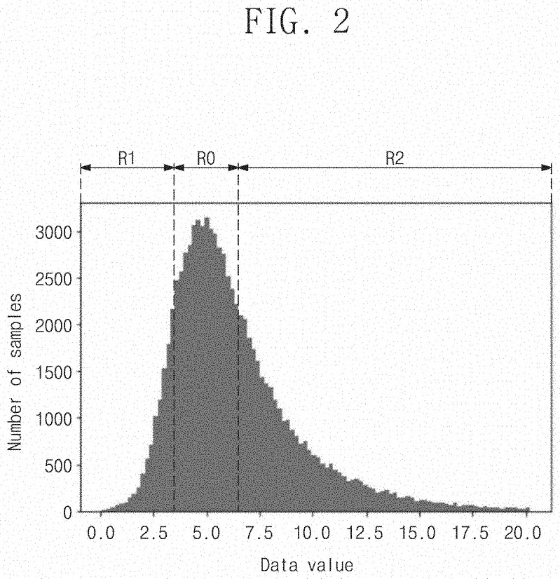

FIG. 2 is a graph describing training data used in a data processing device of FIG. 1. In the graph of FIG. 2, a horizontal axis represents data values, and a vertical axis represents the number of data samples.

Unbalanced distribution or unbalanced data used in the detailed description indicates that the frequency, the number of samples, or distribution of values of data is not uniform. For example, as illustrated in FIG. 2, the training data may have an uneven distribution or an unbalanced distribution. That is, the number of data samples included in a zeroth region RO may be relatively greater than the number of data samples included in first and second regions R1 and R2. In this case, when the weight model is trained without reflecting a loss function according to the present disclosure, prediction data for various input data may converge to the data included in the zeroth region R0. That is, the reliability of the prediction data of the data processing device 100 will be reduced.

In one embodiment, by uniformly sampling the unbalanced training data, the above-mentioned problem may be solved. For example, in the weight model that classifies cats and dogs, when the training data includes 1000 pictures of cats and 1 picture of a dog, uniform training data is obtained by sampling 1 picture of a cat and 1 picture of a dog, respectively. In this case, when the amount of sampled training data is small, the amount of training data may be increased through repeated sampling.

However, the data sampling described above may cause distortion of the training data. An unbalanced characteristic in the training data itself may be an important characteristic of the training data, and artificially distorting it may not reflect the characteristic of the training data to the weight model. For example, in the case of the total cholesterol value included in an EMR (Electronic Medical Record), due to the nature of EMR, many people have values in a normal range, and relatively few people have values in an abnormal range. In detail, since many people with the values in the normal range are unique characteristics of EMR, matching the number of people with the values in the normal range to the number of people with the values in the abnormal range through sampling is difficult to say as training data reflecting the unique characteristics of EMR.

Therefore, there is a need for a method that uses the training data itself rather than distorting the distribution of the training data through sampling, but reflects the distribution of the unbalanced training data (i.e., unique characteristics) in the learning process of the weight model.

According to the present disclosure, since the weight model is updated by reflecting a relatively large loss value with respect to a relatively small number of data samples, the unbalanced distribution (i.e., unique characteristic) of the training data may be reflected in the weight model.

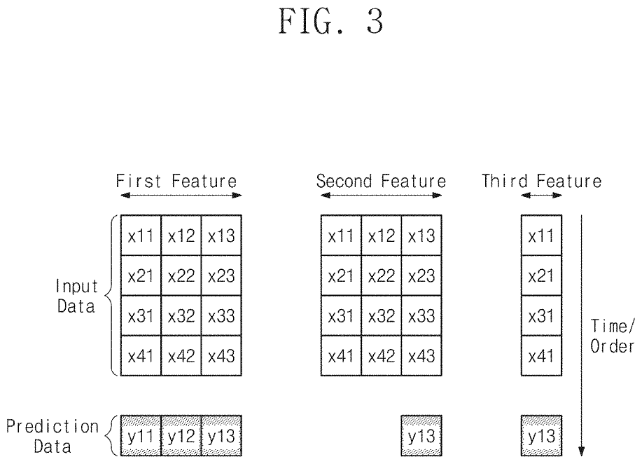

FIG. 3 is a diagram illustrating a form of data used in a data processing device of FIG. 1. Referring to FIG. 3, various data (e.g., training data or input data, etc.) used in the data processing device 100 may be time series data or data having an order. The time series data may be a set of data having a temporal order and recorded according to over time. The time series data may include at least one feature corresponding to each of a plurality of times listed in time series. For example, the time series data may include time series medical data representing a user's health status, such as the electronic medical record (EMR), generated by diagnosis, treatment, or medication prescription at a medical institution. For clarity of description, the time series medical data are described as an example, but the type of time series data is not limited thereto, and the time series data may be generated in various fields such as entertainment, retail, smart management, and the like.

The input data illustrated in FIG. 3 may be data in which one or more features are listed in temporal order. For example, input data having a complex feature such as a first feature or a second feature may include data of x11 to x43. Alternatively, input data having a single feature such as a third feature may include data of x11 to x41. The data processing device 100 may predict prediction data having complex features such as y11, y12, and y13 with respect to the input data having the complex features such as the first feature. Alternatively, the data processing device 100 may predict prediction data having the single feature such as y13 with respect to the input data having the complex features such as the second feature. Alternatively, the data processing device 100 may predict prediction data having a single feature such as y13 with respect to the input data of a single feature such as the third feature.

Hereinafter, so as to easily describe embodiments of the present disclosure, it is assumed that the data processing device 100 predicts prediction data having a single feature with respect to the input data having a single feature such as the third feature. In this case, the input data may be data having the unbalanced characteristic as described with reference to FIG. 2.

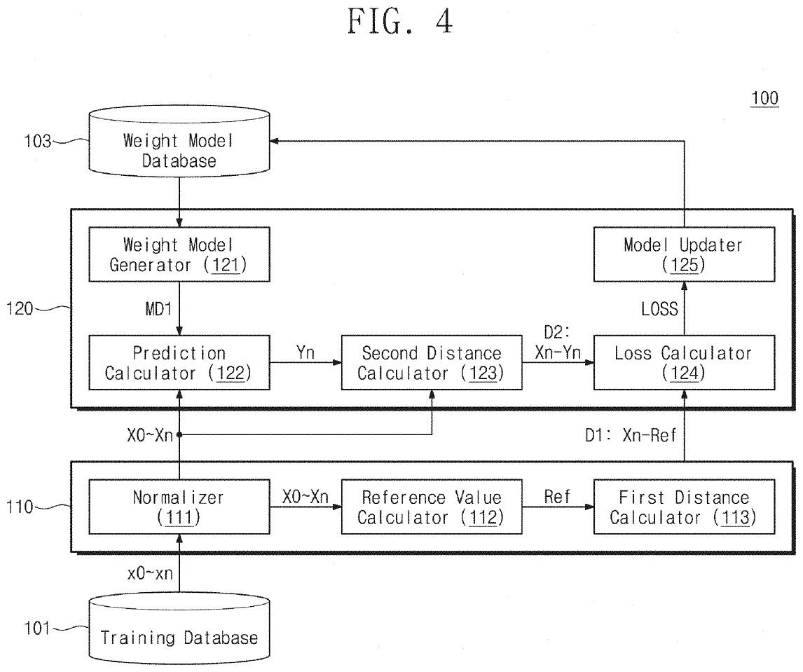

FIG. 4 is a diagram describing a learning process of a data processing device of FIG. 1. In FIG. 4, components unnecessary to describe the learning process of the data processing device 100 are omitted. However, the scope of the present disclosure is not limited thereto.

Referring to FIGS. 1 and 4, the data processing device 100 may include the preprocessor 110 and the learner 120. The preprocessor 110 may perform preprocessing on the training data x0 to xn from the training database 101. The learner 120 may update the weight model based on the training data preprocessed by the preprocessor 110, and may store the updated weight model in the weight model database 103. Hereinafter, for convenience of description, it is assumed that the training data x0 to xn are time series data.

The preprocessor 110 may include a normalizer 111, a reference value calculator 112, and a first distance calculator 113. The normalizer 111 may normalize the data set. For example, the normalizer 111 may receive a plurality of training data x0 to xn from the training database 101 and may normalize the received training data x0 to xn. For example, the plurality of training data x0 to xn stored in the training database 101 may be configured with various features, and may have various ranges of values depending on each feature. The normalizer 111 may perform an operation (i.e., a normalization operation) for converting each of the plurality of training data x0 to xn to values in a predetermined range (e.g., 0 to 1, or −1 to +1, etc.) such that a range (or a scale) of each of the plurality of training data x0 to xn is uniform. The training data x0 to xn may be converted into normalized training data X0 to Xn by the normalization operation of the normalizer 111.

The reference value calculator 112 may calculate a reference value Ref based on the normalized training data X0 to Xn. In an embodiment, the reference value Ref may be a representative value for the normalized training data X0 to Xn. As a more detailed example, the reference value Ref may indicate any one of a mode value, a median value, or a mean value of the normalized training data X0 to Xn. When the normalized training data X0 to Xn have the distribution illustrated in FIG. 2, the reference value Ref may be calculated as a value corresponding to the zeroth region R0 of the graph of FIG. 2.

In an embodiment, the reference value calculator 112 may calculate the reference value Ref based on some or all of the normalized training data X0 to Xn. For example, it is assumed that the target data in the learning process is the n-th data (i.e., Xn). In this case, the reference value calculator 112 may determine the reference value Ref based on the n-th data (i.e., Xn). Alternatively, the reference value calculator 112 may determine the reference value Ref based on all of the normalized training data X0 to Xn. Hereinafter, the target data are described as being included in the training data or the normalized training data, but the scope of the present disclosure is not limited thereto, and the target data may be a part of the training data or the normalized training data, or may be data separated from the training data or the normalized training data.

In an embodiment, when the normalized training data X0 to Xn are composed of the complex features, the reference value calculator 112 may calculate the reference value Ref for each of the complex features.

The first distance calculator 113 may calculate a first distance D1 based on the reference value Ref. The first distance D1 may indicate an error, an absolute value difference, a logical distance, or a Euclidean distance between the reference value Ref and the target data. For example, it is assumed that the target data in the learning process is the n-th data among the plurality of training data or ‘n’ data (i.e., xn) (in this case, the normalized target data are Xn). That is, the target data may refer to actual data, that is, data that are a correct answer, rather than a value predicted through machine learning. In this case, the first distance D1 may be represented as a difference Xn-Ref between the n-th data Xn and the reference value Ref. That the first distance D1 is far (or large) means that the difference between the actual data and the reference value Ref is large. In other words, in the training data having the distribution of FIG. 2, that the target data are included in the zeroth region RO means that the first distance D1 is relatively short, and that the target data are included in the first region R1 means that the first distance D1 is relatively long.

The learner 120 may update the weight model based on the data (e.g., the normalized training data X0 to Xn and the first distance D1) processed by the preprocessor 110. For example, the learner 120 may include a weight model generator 121, a prediction calculator 122, a second distance calculator 123, a loss calculator 124, and a model updater 125.

The weight model generator 121 may generate a first weight model MD1 based on various weights or parameters included in the weight model database 103. In an embodiment, in a state (i.e., initial training) in which separate information is not stored in the weight model database 103, weights corresponding to the first weight model MD1 may have a predetermined value (e.g., 0 or 1, etc.) or an arbitrary value.

The prediction calculator 122 may receive the normalized training data X0 to Xn from the preprocessor 110. The prediction calculator 122 applies the normalized training data X0 to Xn to the first weight model MD1, so that the n-th data or the prediction data for the ‘n’ data (i.e., the ‘n’ prediction data) Yn may be calculated. For example, it is assumed that n-th data among the normalized training data X0 to Xn are the target data in the learning process. In this case, the prediction calculator 122 may input some of the normalized training data X0 to Xn (e.g., X0 to Xn−1) to the first weight model MD1, and the ‘n’ prediction data Yn may be output as an output of the first weight model MD1. That is, the ‘n’ prediction data Yn are not actual data, but data that are predicted through machine learning with respect to the n-th data.

The second distance calculator 123 may calculate a second distance D2 based on the ‘n’ prediction data Yn and the normalized training data X0 to Xn. The second distance D2 may indicate an error, an absolute value difference, a logical distance, or a Euclidean distance between the prediction data and the target data. For example, as described above, it is assumed that the target data in the learning process are the n-th data (i.e., Xn). In this case, the second distance D2 may be represented as a difference (i.e., Xn to Yn) between the target data Xn and the n-th prediction data Yn. That the second distance D2 is long means that the error between the ‘n’ prediction data Yn, which are the prediction result, and the target data Xn, which are the actual data is relatively large, and in contrast, that the second distance D2 is short means that the error between the ‘n’ prediction data Yn, which are the prediction result, and the target data Xn, which are the actual data is relatively small.

The loss calculator 124 may calculate or compensate a loss value LOSS based on the first distance D1 from the first distance calculator 110 of the preprocessor 110 and the second distance D2 from the second distance calculator 123 of the learner 120. In a general weight model, the loss value indicates a difference between a value (i.e., prediction data) predicted through the weight model and a value (i.e., target data) actually intended by a user. That is, in the general weight model, the loss value may be determined based on the second distance D2 (i.e., Xn to Yn).

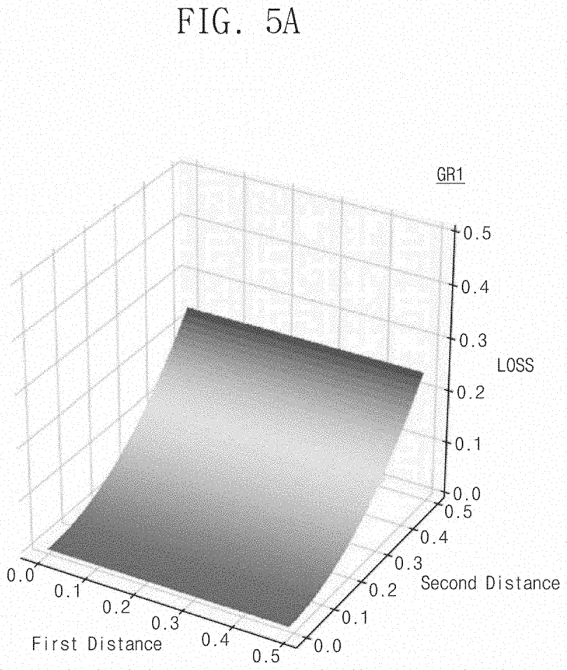

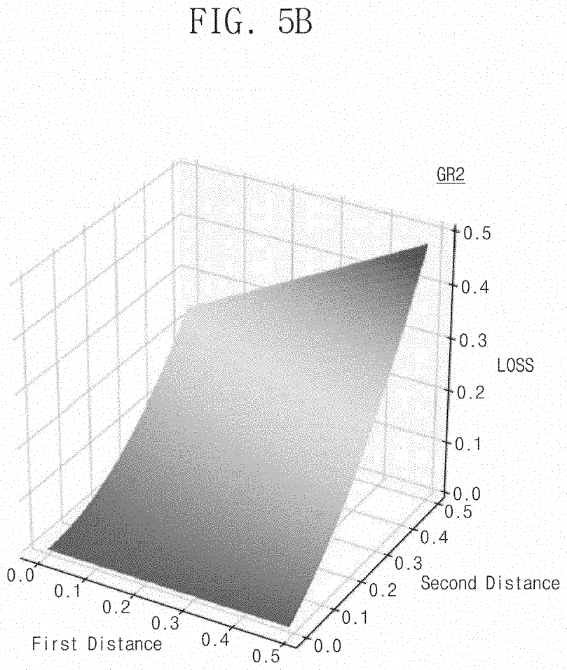

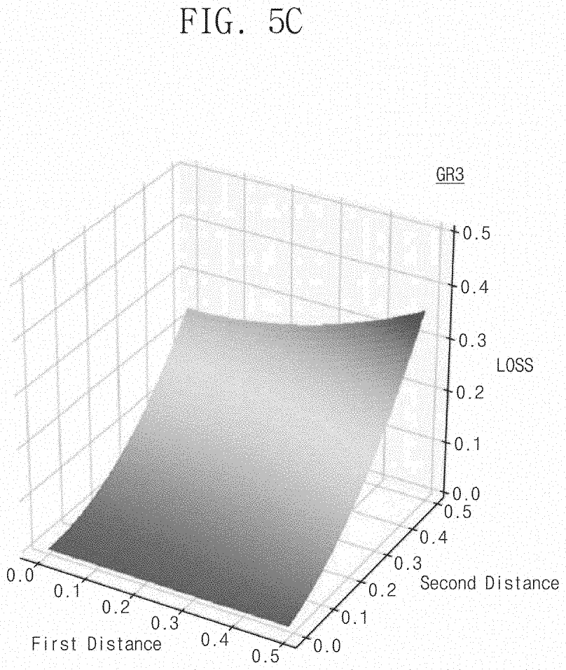

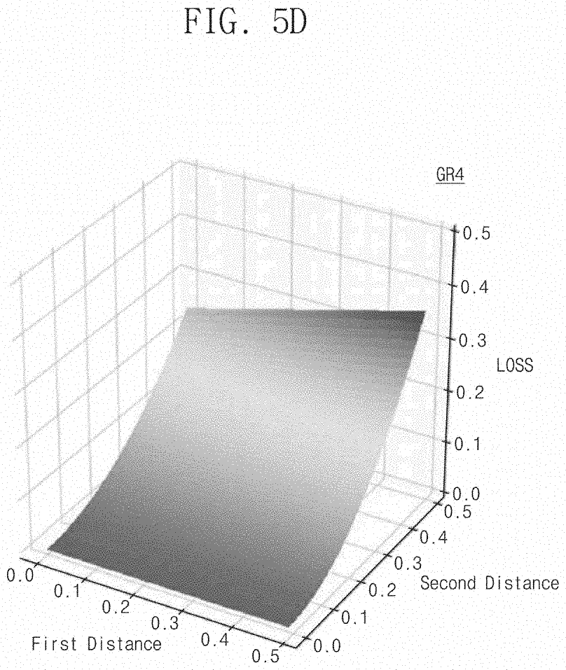

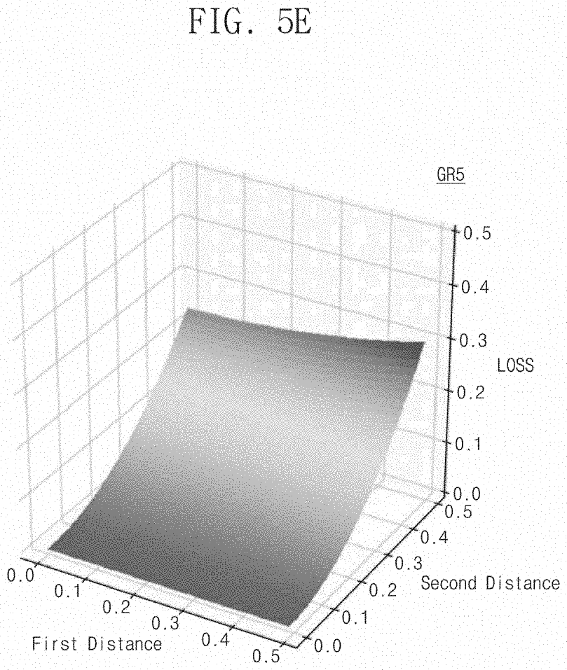

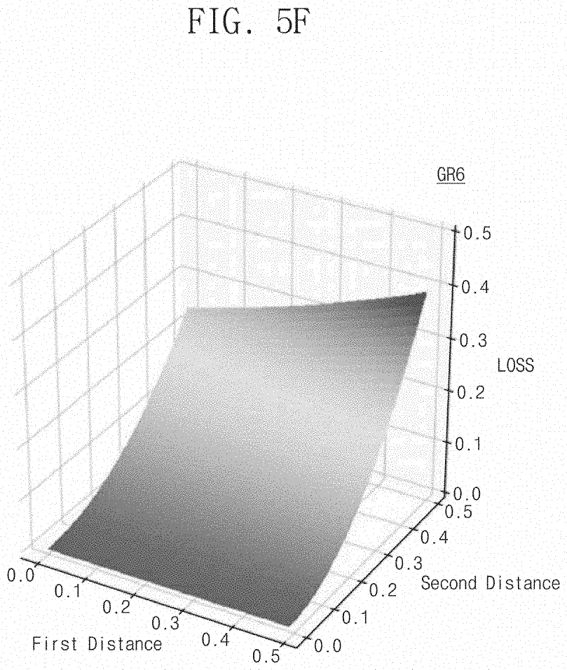

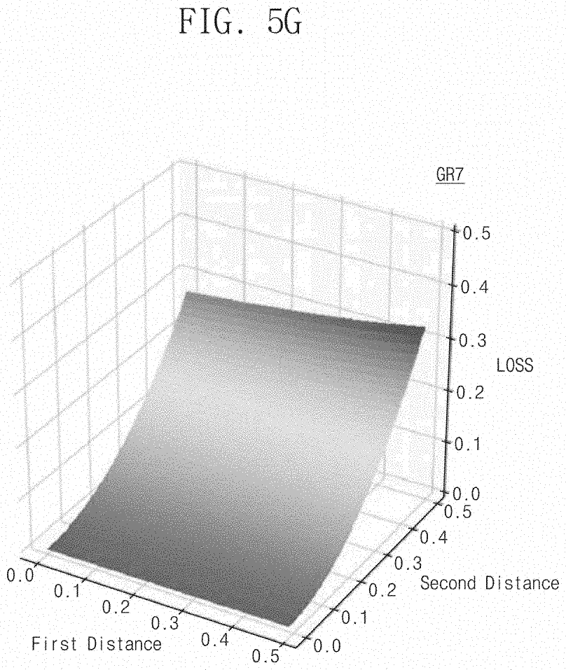

In contrast, the loss calculator 124 according to the present disclosure may calculate or compensate the loss value LOSS based on the first distance D1 and the second distance D2. For example, the loss calculator 124 may increase the loss value LOSS as the first distance D1 and the second distance D2 increase, respectively. As a more detailed example, when the first distance D1 is the same, the loss value LOSS may increase as the second distance D2 increases by an operation of the loss calculator 124. When the second distance D2 is the same, the loss value LOSS may increase as the first distance D1 increases by the operation of the calculator 124. In this case, an amount of increase in the loss value according to the second distance D2 when the first distance D1 is a first value may be less than an amount of increase in the loss value according to the second distance D2 when the first distance D1 is a second value greater than the first value. The loss value calculation and compensation method based on the first and second distances D1 and D2 will be described in more detail with reference to FIGS. 5A to 5G.

In an embodiment, the above-described loss value calculation and compensation method may be performed based on a loss function as described with reference to FIGS. 5A to 5G below. However, the scope of the present disclosure is not limited thereto.

For example, the loss calculator 124 may calculate the loss value LOSS based on the second distance D2. The loss calculator 124 may compensate for the loss value LOSS based on the first distance D1. As a more detailed example, as described above, the first distance D1 may mean the location of the prediction data Yn or the target data Xn on the distribution of the training data. The loss calculator 124 may determine the location or region of the prediction data Yn or the target data Xn on the distribution of the training data based on the first distance D1. The loss calculator 124 may compensate the loss value LOSS based on the location or region of the prediction data Yn or the target data Xn. That is, when the location or region of the prediction data Yn or the target data Xn is included in the zeroth region R0 of FIG. 2 (i.e., the region including the reference value), the loss calculator 124 may calculate the loss value LOSS using first algorithm or may omit a separate compensation for the loss value LOSS. When the location or region of the prediction data Yn or the target data Xn is included in the first region R1 or the second region R2 of FIG. 2 (i.e., the region not including the reference value), the loss calculator 124 may compensate the loss value LOSS using second algorithm such that the loss value LOSS is greater than the loss value calculated by the first algorithm.

In an embodiment, the loss calculator 124 may compare the first distance D1 with a reference distance, and may select the algorithm to be used to calculate the loss value based on the comparison result. For example, when the first distance D1 is less than the reference distance, the loss calculator 124 may calculate the loss value LOSS based on the first and second distances D1 and D2 using the first algorithm, and when the first distance D1 is greater than the reference distance, the loss calculator 124 may calculate the loss value LOSS based on the first and second distances D1 and D2 using the second algorithm. In this case, a rate of change of the loss value LOSS according to the change of the second distance D2 by the first algorithm may be less than a rate of change of the loss value LOSS according to the change of the second distance D2 by the second algorithm. In an embodiment, a plurality of reference distances may be set to distinguish a plurality of regions, and algorithm selected according to the region including the first distance D1 may vary.

Hereinafter, for convenience of description, a configuration for calculating or compensating for the loss value LOSS based on the loss function is described, but the scope of the present disclosure is not limited thereto, and as described above, the loss value LOSS may be compensated or calculated in stages depending on the first distance D1.

The model updater 125 may receive the calculated loss value LOSS from the loss calculator 124 and may update the weight model based on the received loss value LOSS. For example, the model updater 125 may update the weights of the weight model such that the loss value LOSS is minimized.

As described above, in the learning process, the data processing device 100 according to an embodiment of the present disclosure may calculate or compensate the loss value LOSS based on the first distance D1 indicating the difference between the target data Xn and the reference value Ref and the second distance D2 indicating the difference between the target data Xn and the prediction data Yn. Therefore, with respect to the unbalanced training data, the unique characteristics of the training data may be reflected to the weight model without distortion of the separate training data. Accordingly, the reliability of the data processing device 100 is improved.

FIGS. 5A to 5G are graphs describing an operation of a loss calculator of FIG. 4. For convenience of description, a loss value calculation method according to the present disclosure will be described with reference to various loss functions with reference to FIGS. 5A to 5G. However, the scope of the present disclosure is not limited thereto, and the loss value LOSS may be calculated or compensated through various methods.

Hereinafter, symbols n, Xn, Yn, Ref, D1, and D2 are used to describe FIGS. 5A to 5G. The ‘n’ refers to the number of training data included in a mini-batch used in the learning process, Xn refers to the target data (i.e., the actual data for the prediction result), Yn refers to the prediction data calculated through machine learning,

Ref denotes the reference value calculated by the preprocessor 110, D1 denotes the first distance calculated by the preprocessor 110 (i.e., the difference between the target data and the reference value), and D2 denotes the second distance (i.e., the difference between the target data and the prediction data) calculated by the learner 120.

The loss value may be calculated by a loss function as in Equation 1.

$${LOSS}_{mse} = \frac{1}{n} \sum {( {X}_{n} - {Y}_{n} )}^{2} = \frac{1}{n} \sum D {2}^{2} \qquad [ Equation 1 ]$$

Since the reference symbols of Equation 1 are similar to those described above, a detailed description thereof will be omitted to avoid redundancy. The loss value LOSSmse may be calculated based on a mean squared error (MSE) method used in conventional machine learning. In this case, the loss value LOSSmse calculated based on Equation 1 may be the same as a first graph GR1 of FIG. 5A. That is, the loss value LOSSmse may be calculated based on the second distance D2, and the size of the first distance D1 does not affect the loss value LOSSmse. That is, the loss value used in the conventional machine learning is simply determined based on a distance between the prediction data and the target data, and does not reflect the characteristics of the distribution of the training data.

In an embodiment, referring to FIG. 5B, the loss value may be calculated by a loss function as in Equation 2.

$${LOSS}_{1} = \frac{1}{n} \sum ( {( {X}_{n} - {Y}_{n} )}^{2} + \vert {X}_{n} - {Y}_{n} \vert \times \vert {X}_{n} - Ref \vert ) = \frac{1}{n} \sum ( D {2}^{2} + \vert D 2 \vert \times \vert D 1 \vert ) \qquad [ Equation 2 ]$$

Since the reference symbols of Equation 2 are similar to those described above, a detailed description thereof will be omitted to avoid redundancy. A loss value LOSS1 according to Equation 2 of the present disclosure may be the same as a second graph GR2 of FIG. 5B, and may be determined based on the first distance D1 and the second distance D2.

In an embodiment, the loss value may be calculated by a loss function as in Equation 3.

$${LOSS}_{2} = \frac{1}{n} \sum ( {( {X}_{n} - {Y}_{n} )}^{2} + {( {X}_{n} - {Y}_{n} )}^{2} \times \vert {X}_{n} - Ref \vert ) = \frac{1}{n} \sum ( D {2}^{2} + D {2}^{2} \times \vert D 1 \vert ) \qquad [ Equation 3 ]$$

Since the reference symbols of Equation 3 are similar to those described above, a detailed description thereof will be omitted to avoid redundancy. A loss value LOSS2 according to Equation 3 of the present disclosure may be the same as a third graph GR3 of FIG. 5C, and may be determined based on the first distance D1 and the second distance D2.

In an embodiment, the loss value may be calculated by a loss function as in Equation 4.

$${LOSS}_{3} = \frac{1}{n} \sum ( {( {X}_{n} - {Y}_{n} )}^{2} + \vert {X}_{n} - {Y}_{n} \vert \times {( {X}_{n} - Ref )}^{2} ) = \frac{1}{n} \sum ( D {2}^{2} + \vert D 2 \vert \times D {1}^{2} ) \qquad [ Equation 4 ]$$

Since the reference symbols of Equation 4 are similar to those described above, a detailed description thereof will be omitted to avoid redundancy. A loss value LOSS3 according to Equation 4 of the present disclosure may be the same as a fourth graph GR4 of FIG. 5D, and may be determined based on the first distance D1 and the second distance D2.

In an embodiment, the loss value may be calculated by a loss function as in Equation 5.

$${LOSS}_{4} = \frac{1}{n} \sum ( {( {X}_{n} - {Y}_{n} )}^{2} + {( {X}_{n} - {Y}_{n} )}^{2} \times {( {X}_{n} - Ref )}^{2} ) = \frac{1}{n} \sum ( D {2}^{2} + D {2}^{2} \times D {1}^{2} ) \qquad [ Equation 5 ]$$

Since the reference symbols of Equation 5 are similar to those described above, a detailed description thereof will be omitted to avoid redundancy. The loss value LOSS4 according to Equation 5 of the present disclosure may be the same as a fifth graph GR5 of FIG. 5E, and may be determined based on the first distance D1 and the second distance D2.

In an embodiment, the loss value may be calculated by a loss function as in Equation 6.

$${LOSS}_{5} = \frac{1}{n} \sum ( {( {X}_{n} - {Y}_{n} )}^{2} + \times {e}^{\vert {X}_{n} - Ref \vert} ) = \frac{1}{n} \sum ( D {2}^{2} \times {e}^{\vert D 1 \vert} )$$

Since the reference symbols of Equation 6 are similar to those described above, a detailed description thereof will be omitted to avoid redundancy. The loss value LOSS5 according to Equation 6 of the present disclosure may be the same as the sixth graph GR6 of FIG. 5F, and may be determined based on the first distance D1 and the second distance D2.

In an embodiment, the loss value may be calculated by a loss function as in Equation 7.

$${LOSS}_{6} = \frac{1}{n} \sum ( {( {X}_{n} - {Y}_{n} )}^{2} + ( {e}^{( 2 \times \vert {X}_{2} - Ref \vert - 1 )} + 1 ) ) = \frac{1}{n} \sum ( D {2}^{2} \times {e}^{( 2 \times \vert D 1 \vert - 1 )} - 1 ) \qquad [ Equation 7 ]$$

Since the reference symbols of Equation 7 are similar to those described above, a detailed description thereof will be omitted to avoid redundancy. A loss value LOSS6 according to Equation 7 of the present disclosure may be the same as a seventh graph GR7 of FIG. 5F, and may be determined based on the first distance D1 and the second distance D2.

As described above, the learner 120 of the present disclosure may calculate the loss value based on various loss functions. The loss functions described with reference to Equations 1 to 7 are simple examples, and the scope of the present disclosure may not be limited thereto. For example, the learner 120 may calculate or compensate the loss value such that the loss value LOSS increases as the first distance D1 and the second distance D2 increase. As a more detailed example, an amount of increase in the loss value according to the increase of the first distance D1 when the second distance D2 is a first value may be less than an amount of increase in the loss value according to the increase of the first distance D1 when the second distance D2 is a second value greater than the first value. In other words, as the difference between the target data Xn and the reference value Ref increases, the rate at which the loss value increases (i.e., the increase rate) may increase.

Therefore, without distortion of the training data, the unique characteristics (e.g., the unbalanced distribution) of the training data may be reflected to the weight model through loss compensation, and accordingly, the reliability of the data processing device 100 may be improved.

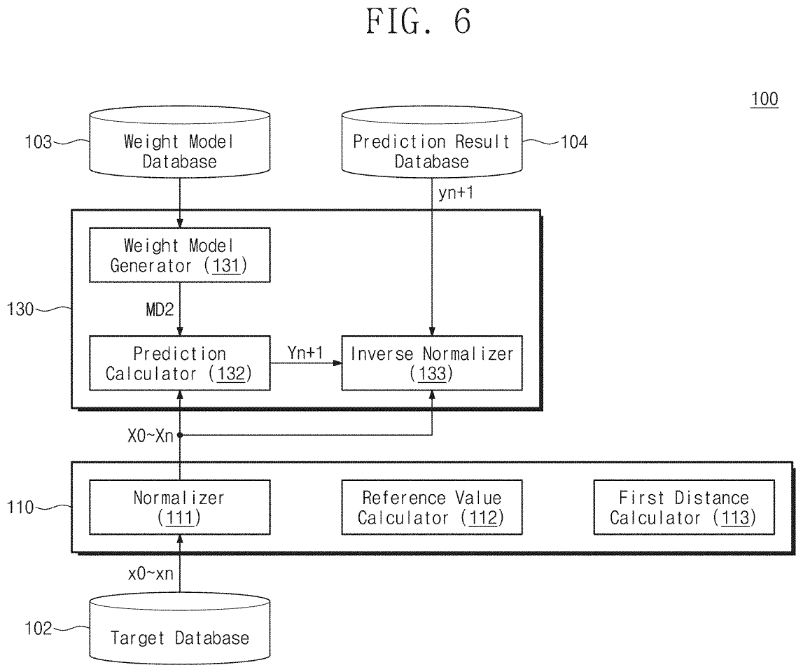

FIG. 6 is a diagram describing a prediction process of a data processing device of FIG. 1. In FIG. 6, components unnecessary to describe the prediction process of the data processing device 100 are omitted. However, the scope of the present disclosure is not limited thereto.

Referring to FIGS. 1 and 6, the data processing device 100 may include the preprocessor 110 and the predictor 130. The preprocessor 110 may include the normalizer 111, the reference value calculator 112, and the first distance calculator 113. The normalizer 111 of the preprocessor 110 may receive input data x0 to xn from the target database 102, and may normalize the received input data x0 to xn. Since the remaining components are similar to those described above, additional description thereof will be omitted to avoid redundancy.

The predictor 130 may include a weight model generator 131, a prediction calculator 132, and an inverse normalizer 133. The weight model generator 131 may generate a second weight model MD2 based on various weights or parameters stored in the weight model database 103. In an embodiment, the second weight model MD2 may be generated based on various parameters or various weights stored in the weight model database 103. In an embodiment, the second weight model MD2 may be generated based on the weight model updated through the above-described learning process.

The prediction calculator 132 may receive the normalized input data X0 to Xn from the preprocessor 110. The prediction calculator 132 may calculate (n+1)-th data or prediction data (i.e., the (n+1)-th prediction data) for the (n+1)-th data Yn+1 by applying the normalized input data XO to Xn to the second weight model MD2.

The inverse normalizer 133 may inverse normalize the (n+1)-th prediction data Yn+1. For example, the inverse normalizer 133 may inverse normalize the (n+1)-th prediction data Yn+1 to a value corresponding to an original range, based on the maximum value and minimum value information for the input data used in the normalizer 111. The inverse normalized (n+1)-th prediction data yn+1 may be stored in the prediction result database 104.

In one embodiment, so as to easily describe the present disclosure, the learning process and the prediction process are described as separate configurations, but the scope of the present disclosure is not limited thereto. For example, the data processing device 100 according to the present disclosure may perform the learning process and the prediction process simultaneously or in parallel. Alternatively, the data processing device 100 according to the present disclosure may use the result of the prediction process in the result of the learning process or may use the result of the learning process in the prediction process.

Alternatively, similar components among the components of the preprocessor 110, the learner 120, and the predictor 130 of the data processing device 100 according to the present disclosure share one functional block or may be implemented with the same module. For example, the weight model generator 121 of the learner 120 and the weight model generator 131 of the predictor 130 may be configured to perform the same function, and in this case, may be configured to share the same functional block or the same module. That is, it will be understood that the above-described embodiments are merely examples, and the scope of the present disclosure is not limited thereto.

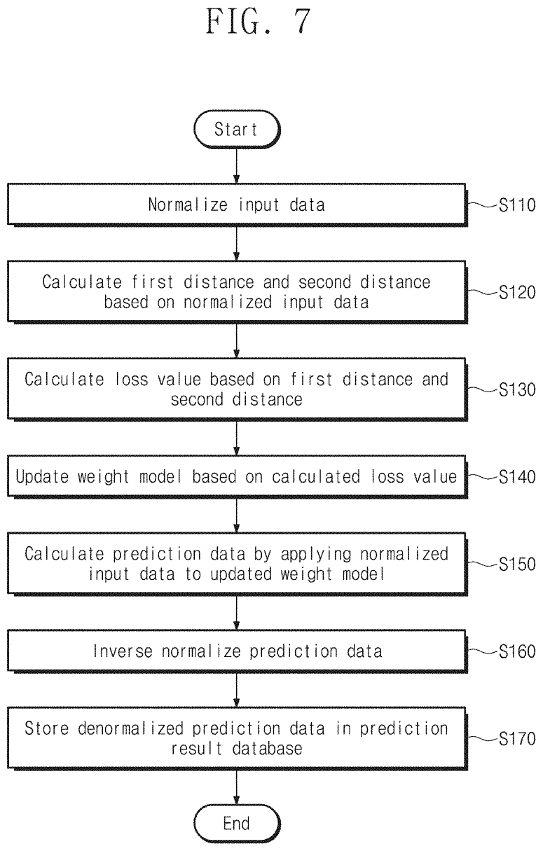

FIG. 7 is a flowchart illustrating an operation of a data processing device of FIG. 1. Referring to FIGS. 1 and 7, in operation S110, the data processing device 100 may normalize input data. For example, the normalization operation on the input data in operation S110 may be performed by the normalizer 111 of the preprocessor 110 described above. The input data may be provided from the training database 101 or the target database 102.

In operation S120, the data processing device 100 may calculate the first distance and the second distance based on the normalized input data. For example, the first distance may be calculated by the reference value calculator 112 and the first distance calculator 113 of the preprocessor 110 described above, and the second distance may be calculated by the prediction calculator 122 and the second distance calculator 123 of the learner 120 described above. The first distance indicates the difference between the target data and the reference value, and the second distance indicates the difference between the target data and the prediction data.

In operation S130, the data processing device 100 may calculate a loss value based on the first distance and the second distance. For example, the data processing device 100 may calculate or compensate the loss value such that the loss value increases as each of the first distance and the second distance increases. The calculation on the loss value may be performed by the loss calculator 124 of the learner 120 described above. The calculation of the loss value may be accomplished based on the various loss functions described above or in various other manners. However, the scope of the present disclosure is not limited thereto, and the subject matter of the present disclosure with respect to the loss value may be modified in various ways, and since the conceptual configuration thereof has been described above, additional description thereof will be omitted to avoid redundancy.

In operation S140, the data processing device 100 may update the weight model based on the calculated loss value. For example, the data processing device 100 may determine or calculate the weight model, or various parameters or weights of the weight model such that the calculated loss value is minimized The determined parameters or weights may be stored in the weight model database 103.

In operation S150, the data processing device 100 may calculate the prediction data by applying the normalized input data to the updated weight model. For example, the data processing device 100 may generate final prediction data associated with the normalized input data by applying the input data normalized in operation S110 to the weight model updated in operation S140. The operation of generating the prediction data may be performed by the predictor 130 described above.

In operation S160, the data processing device 100 may inverse normalize the prediction data. In operation S170, the data processing device 100 may store the inverse normalized prediction data in the prediction result database 104.

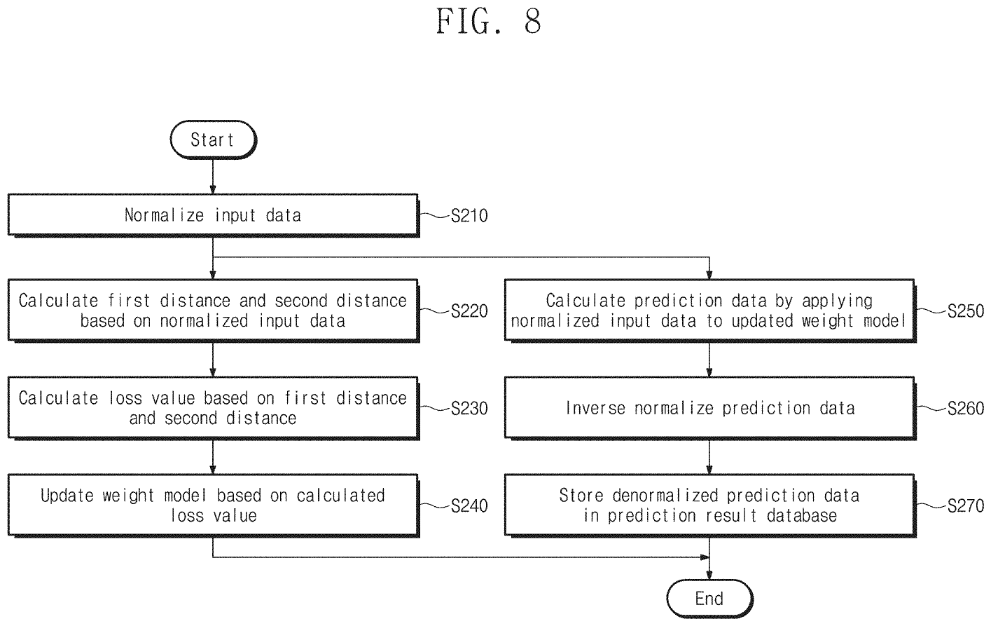

FIG. 8 is a flowchart illustrating an operation of a data processing device of FIG. 1. Referring to FIGS. 1 and 8, the data processing device 100 may perform operation S210 to operation S270. The operations in operation S210 to operation S270 are similar to the operations in operation S110 to operation S170 of FIG. 7, and thus, additional description will be omitted to avoid redundancy.

In an embodiment, according to the flowchart of FIG. 7, the data processing device 100 may sequentially perform the learning process and the prediction process. In contrast, according to the flowchart of FIG. 8, the data processing device 100 may perform the learning process and the prediction process in parallel. In detail, the learning process (e.g., operations S220 to S240) may be performed simultaneously or in parallel with the prediction process (i.e., operations S250 to S270). In this case, the weight model generated in the prediction process may be a weight model updated through a previous learning process, and other operations and configurations may be similar to those described above.

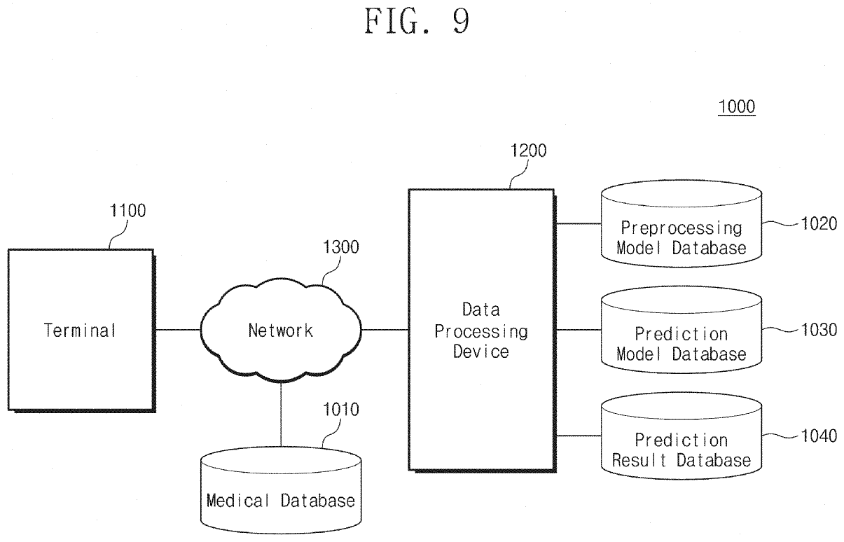

FIG. 9 is a diagram illustrating a health state prediction system to which a data processing device according to the present disclosure is applied. Referring to FIG. 9, a health state prediction system 1000 includes a terminal 1100, a data processing device 1200, and a network 1300.

The terminal 1100 may collect time series data (e.g., medical information) from a user and may provide it to the data processing device 1200 or a medical database 1010 through the network 1300. For example, the terminal 1100 may collect the time series data from the medical database 1010 or the like. The terminal 1100 may be one of various electronic devices capable of receiving the time series data from a user, such as a smart phone, a desktop, a laptop computer, and a wearable device. The terminal 1100 may include a communication module or a network interface to transmit the time series data through the network 130. Although FIG. 9 illustrates one terminal 1100, the present disclosure is not limited thereto, and the time series data from a plurality of terminals may be provided to the data processing device 1200.

The medical database 1010 is configured to integrate and manage medical data for various users. The medical database 1010 may include the training database 101 or the target database 102 of FIG. 1. For example, the medical database 1010 may receive the medical data from public institutions, hospitals, users, etc. The medical database 1010 may be implemented in a server or a storage medium. The medical data may be time series managed in the medical database 1010, may be grouped, and then may be stored. The medical database 1010 may periodically provide the time series data to the data processing device 1200 through the network 1300.

The time series data may include time series medical data representing a user's health status generated by diagnosis, treatment, or medication prescription at a medical institution, such as the Electronic Medical Record (EMR). The time series data may be generated when a user visits a medical institution for diagnosis, treatment, or medication prescription. The time series data may be data listed in time series according to a visit of a medical institution. The time series data may include a plurality of features generated based on a diagnosed, treated, or prescribed feature. For example, the feature may include data measured by a test, such as blood pressure, or data indicating the degree of a disease, such as arteriosclerosis.

The data processing device 1200 may build a weight model through the time series data received from the medical database 1010 (or the terminal 1100). For example, the weight model may include a prediction model for predicting a future health state based on the time series data. For example, the weight model may include a preprocessing model for preprocessing the time series data. The data processing device 1200 may train the weight model through the time series data received from the medical database 1010 and may generate a weight group. To this end, the preprocessor 110 and the learner 120 described with reference to FIGS. 1 to 8 may be implemented in the data processing device 1200.

The data processing device 1200 may process the time series data received from the terminal 1100 or the medical database 1010 based on the built weight model. The data processing device 1200 may preprocess the time series data based on the built preprocessing model. The data processing device 1200 may analyze preprocessed time series data based on the built prediction model. As a result of the analysis, the data processing device 1200 may calculate a prediction result corresponding to the prediction time. The prediction result may correspond to the user's future health state. To this end, the preprocessor 110 and the predictor 130 described with reference to FIGS. 1 to 8 may be implemented in the data processing device 1200.

A preprocessing model database 1020 is configured such that the preprocessing model and the weight group generated by learning in the data processing device 1200 are integrated and managed. The preprocessing model database 1020 may be implemented in a server or a storage medium.

A prediction model database 1030 is configured such that the prediction model and the weight group generated by learning in the data processing device 1200 are integrated and managed. The prediction model database 1030 may include the weight model database 103 of FIG. 1. The prediction model database 1030 may be implemented in a server or a storage medium. The prediction model database 1030 may be learned or updated through the learning process described with reference to FIGS. 1 to 8.

A prediction result database 1040 is configured such that the prediction results analyzed by the data processing device 1200 are integrated and managed. The prediction result database 1040 may include the prediction result database 104 described with reference to FIGS. 1 to 8. The prediction result database 1040 may be implemented in a server or a storage medium.

The network 1300 may be configured to perform data communication among the terminal 1100, the medical database 1010, and the data processing device 1200. The terminal 1100, the medical database 1010, and the data processing device 1200 may transmit and receive data through the network 1300 by wire or wirelessly.

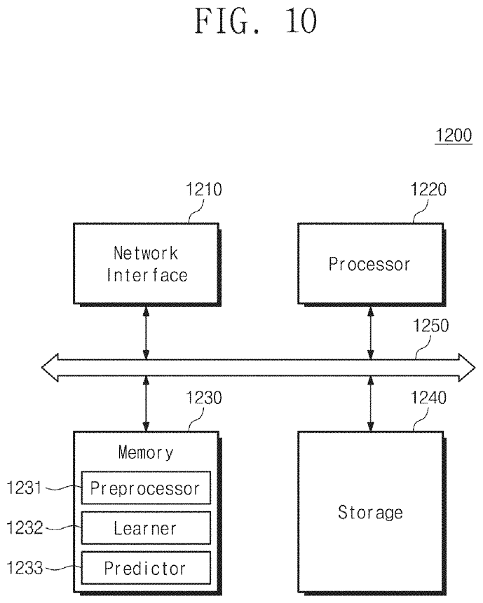

FIG. 10 is a block diagram illustrating a data processing device according to an embodiment of the present disclosure. The block diagram of FIG. 10 may be understood as a structure in which the data processing device described with reference to FIGS. 1 to 8 is implemented in a hardware form, but the structure of the data processing device according to the present disclosure is not limited thereto.

Referring to FIG. 10, the data processing device 1200 may include a network interface 1210, a processor 1220, a memory 1230, storage 1240, and a bus 1250. For example, the data processing device 1200 may be implemented with a server, but is not limited thereto.

The network interface 1210 is configured to receive the time series data provided from the terminal 1100 or the medical database 1010 through the network 1300 of FIG. 9. The network interface 1210 may provide the received time series data to the processor 1220, the memory 1230, or the storage 1240 through the bus 1250. In addition, the network interface 1210 may be configured to provide a prediction result of a future health state generated in response to the received time series data to the terminal 1100 or the like through the network 1300 of FIG. 9.

The processor 1220 may function as a central processing unit of the data processing unit 1200. The processor 1220 may perform control operations and

calculation operations required to implement preprocessing and data analysis of the data processing device 1200. For example, under the control of the processor 1220, the network interface 1210 may receive the time series data from the outside. Under the control of the processor 1220, the calculation operation for generating the weight group of the prediction model may be performed, and the prediction result may be calculated using the prediction model. The processor 1220 may operate by utilizing an operation space of the memory 1230, and may read files for driving an operating system and executable files of applications from the storage 1240. The processor 1220 may execute the operating system and various applications.

The memory 1230 may store data and process codes processed or to be processed by the processor 1220. For example, the memory 1230 may store the time series data, information for performing the preprocessing operation of the time series data, information for calculating the first and second distances, and information for compensating for the loss value based on the first and second distances. The memory 1230 may be used as a main memory device of the data processing device 1200. The memory 1230 may include a dynamic random access memory (DRAM), a static RAM (SRAM), a phase-change RAM (PRAM), a magnetic RAM (MRAM), a ferroelectric RAM (FeRAM), a resistive RAM (RRAM), etc.

A preprocessor 1231, a learner 1232, and a predictor 1233 may be loaded into the memory 1230, and may be executed. The preprocessor 1231, the learner 1232, and the predictor 1233 correspond to the preprocessor 110, the learner 120, and the predictor 130 of FIG. 1, respectively. The preprocessor 1231, the learner 1232, and the predictor 1233 may be a part of the operation space of the memory 1230. In this case, the preprocessor 1231, the learner 1232, and the predictor 1233 may be implemented as firmware or software. For example, the firmware may be stored in the storage 1240 and loaded into the memory 1230 when the firmware is executed. The processor 1220 may execute the firmware loaded into the memory 1230. The preprocessor 1231, the learner 1232, and the predictor 1233 may be executed under the control of the processor 1220 to perform the operations described with reference to FIGS. 1 to 9.

The storage 1240 may store data generated for long-term storage by the operating system or applications, a file for driving the operating system, or executable files of applications. For example, the storage 1240 may store files for execution of the preprocessor 1231, the learner 1232, and the predictor 1233. The storage 1240 may be used as an auxiliary memory device of the data processing device 1200. The storage 1240 may include a flash memory, a PRAM, an MRAM, a FeRAM, an RRAM, etc.

The bus 1250 may provide communication paths among the components of the data processing device 1200. The network interface 1210, the processor 1220, the memory 1230, and the storage 1240 may exchange data with one another through the bus 1250. The bus 1250 may be configured to support various types of communication formats used in the data processing device 1200.

According to an embodiment of the present disclosure, when training data have unbalanced characteristics, the data processing device may apply the unbalanced distribution characteristic of the training data to a weight model without separate distortion (e.g., sampling) of the training data. Accordingly, a device for processing unbalanced data with improved reliability and an operating method thereof are provided.

The above description refers to embodiments for implementing the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A data processing device configured to process unbalanced data, comprising:
a preprocessor configured to calculate a reference value based on a plurality of training data and target data; and
a learner configured to apply the plurality of training data to a first weight model to generate first prediction data, to calculate a loss value based on a first distance between the target data and the reference value and a second distance between the target data and the first prediction data, and to update the first weight model based on the calculated loss value, and
wherein the plurality of training data and the target data have an unbalanced distribution.

2. The data processing device of claim 1, wherein the reference value is one of a mode value, a median value, and a mean value associated with the plurality of training data and the target data.

3. The data processing device of claim 1, wherein the preprocessor includes:
a normalizer configured to perform a normalization operation on a data set from an external training database to generate the plurality of training data and the target data;
a reference value calculator configured to calculate the reference value based on the plurality of training data and the target data; and
a first distance calculator configured to calculate the first distance based on the target data and the reference value.

4. The data processing device of claim 3, wherein the learner includes:
a first weight model generator configured to generate the first weight model from an external weight model database;
a first prediction calculator configured to calculate the first prediction data by applying the training data to the first weight model;
a second distance calculator configured to calculate the second distance based on the target data and the first prediction data;
a loss calculator configured to calculate the loss value based on the first distance and the second distance; and
a model updater configured to update a plurality of parameters and a plurality of weights included in the first weight model based on the loss value to generate a second weight model, and to store the second weight model in the external weight database.

5. The data processing device of claim 4, wherein the normalizer is further configured to perform the normalization operation on a data set from an external target database to generate a plurality of input data, and
the data processing device further comprising:
a predictor configured to apply the plurality of input data to a weight model from the external weight model database to generate result data.

6. The data processing device of claim 5, wherein the predictor includes:
a second weight model generator configured to generate the weight model from the external weight database;
a second prediction calculator configured to calculate result data by applying the plurality of input data to the weight model; and
an inverse normalizer configured to perform an inverse normalization operation on the second prediction data and store the inverse normalized second prediction data in an external prediction result database.

7. The data processing device of claim 4, wherein the loss calculator calculates the loss value using a loss function based on the first distance and the second distance.

8. The data processing device of claim 1, wherein the loss value increases as the first distance or the second distance increases.

9. The data processing device of claim 8, wherein a first increase amount of the loss value depending on an increase of the second distance when the first distance is a first value is less than a second increase amount of the loss value depending on the increase of the second distance when the first distance is a second value greater than the first value.

10. The data processing device of claim 1, wherein the learner selects one of a plurality of algorithms based on the first distance, and calculates the loss value based on the first distance and the second distance using the selected algorithm.

11. The data processing device of claim 1, wherein the plurality of training data are time series data.

12. A method of operating a data processing device configured to process unbalanced data, the method comprising:
calculating a reference value based on a plurality of training data and target data;
calculating a first distance between the target data and the reference value;
generating first prediction data by applying the plurality of training data to a first weight model generated from an external weight model database;
calculating a second distance between the target data and the first prediction data;
calculating a loss value based on the first distance and the second distance; and
generating a second weight model by updating the first weight model based on the loss value, and storing the second weight model in the external weight model database.

13. The method of claim 12, wherein the loss value increases as the first distance or the second distance increases, and
wherein a first increase rate of the loss value depending on the second distance when the first distance is a first value is less than a second increase rate of the loss value depending on the second distance when the first distance is a second value greater than the first value. 25

14. The method of claim 12, wherein the loss value increases as the first distance or the second distance increases, and
wherein, when the first distance is less than a reference distance, a loss value is calculated based on the first distance and the second distance using a first algorithm, and when the first distance is greater than the reference distance, the loss value is calculated based on the first distance and the second distance using a second algorithm, and
wherein a first change rate of the loss value depending on a change of the second distance by the first algorithm is less than a second change rate of the loss value depending on a change of the second distance by the second algorithm.

15. The method of claim 12, further comprising:
generating second prediction data by applying the plurality of input data to the second weight model generated from the external weight model database.
